(19) United States
(12) Patent Application Publication
(10) Pub. No.: US 2008/0092496 A1
(43) Pub. Date: Apr. 24, 2008

(54) CUSTOM-COLORABLE PROTECTIVE TACK FOR HORSES

(76) Inventors: STEVE HUFFMAN, Nampa, ID (US); TERI HALLMAN, Eagle, ID (US)

Correspondence Address: PEDERSEN & COMPANY, PLLC, P.O. BOX 2666, BOISE, ID, 83701, US

(21) Appl. No.: 11/738,403

(22) Filed: Apr. 20, 2007

Related U.S. Application Data
(60) Provisional application No. 60/794,148, filed on Apr. 20, 2006.

(51) Int. Cl. B68B 5/00

(52) U.S. Cl. 54/1

(57) ABSTRACT

The present invention is custom-colorable protective tack for horses. Preferably, the tack is “bell boots”, “splint boots” and “skid boots”. By “custom” we mean that the tack is conveniently and economically colorable by the rider, owner, groom, etc., after delivery by the finished tack vendor, with commonly available utensils and raw materials that may be applied by hand by any normal person, for example, on white FABLENE™ material with a SHARPIE™ pen. Also, by “custom” we mean that the tack material is conveniently and economically colorable by the tack vendor, or at its direction, before assembly of the finished tack. By “colorable” we mean that contrast in color may be applied to the tack so that images are created thereon. Also, the present invention is a method for custom-coloring such tack. Also, the present invention is a special kit supplied with “bell boots”, “splint boots” and/or “skid boots” of a material which is especially amenable to receiving fast non-fading images from permanent ink markers/pens, as well as a supply of a selection of different colors of the markers/pens.

This application claims priority of Provisional Application Ser. No. 60/794,148, filed Apr. 20, 2006, and entitled “Custom-Colorable Protective Tack For Horses”, which is hereby incorporated by reference.

### BACKGROUND OF THE INVENTION

1. Field of the Invention

This invention relates generally to protective tack for horses, especially “bell boots”, “splint boots” and “skid boots”. More specifically, this invention relates to manufacturing such protective tack from special materials, and conveniently custom-coloring the tack with permanent ink.

2. Related Alt

Modern performance horse people provide substantial protective tack to prevent damage to the horses' feet and legs during competition. For example, horse people provide “bell boots” to protect the horses' pastern and coronet, and “splint boots” to protect the tendons of the lower legs. Also horse people provide “skid boots” to protect the skin of the lower back legs.

Still, until now these “bell boots”, “splint boots” and “skid boots” have been typically provided in one color—for example, all black, or all white, etc. If they have been provided in more than one color, then typically the color choices and patterns have been few, and pre-determined by the manufacturer. This is not amenable to convenient color coordination with today's highly decorative and colorful riding outfits and other tack.

Still then, there continues to be a need for custom-colorable protective tack for horses. Also, there is a need for such tack when custom-colored to remain fast, bright and colorful. Also, there is a need for such tack to be custom-colored conveniently and economically. The present invention addresses these needs.

### SUMMARY OF THE INVENTION

The present invention is custom-colorable protective tack for horses. Preferably, the tack is “bell boots”, “splint boots” and “skid boots”.

By “custom” we mean that the tack is conveniently and economically colorable by the rider, owner, groom, etc., after delivery by the finished tack vendor, with commonly available utensils and raw materials that may be applied by hand by any normal person. Also, by “custom” we mean that the tack material is conveniently and economically colorable by the tack vendor, or at its direction, before assembly of the finished tack. By “colorable” we mean that contrast in color may be applied to the tack so that images are created thereon. Preferably, the images are fast and bright, and do not fade.

Also, the present invention is a method for custom-coloring such tack. Also, the present invention is a special kit supplied with “bell boots”, “splint boots” and/or “skid boots” of a material which is especially amenable to receiving fast non-fading images from permanent ink markers/pens, as well as a supply of a selection of different colors of the markers/pens.

### BRIEF DESCRIPTION OF THE DRAWINGS

FIG. 1 is a front perspective view of a custom-colored bell boot according to one embodiment of the present invention.

FIG. 2 is a rear perspective view of the bell boot in FIG. 1.

FIG. 3 is a light side perspective view of the bell boot in FIG. 1.

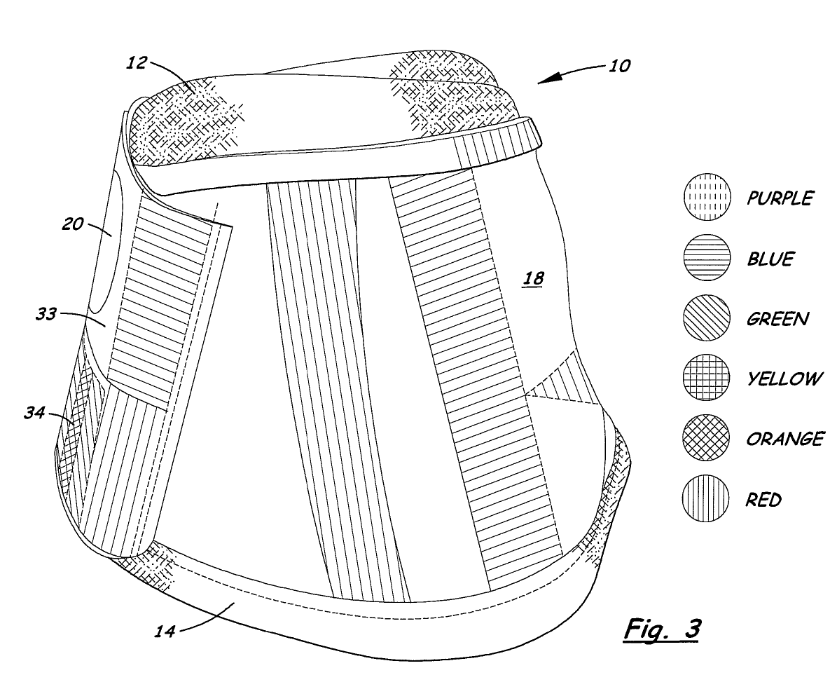

FIG. 4 is a top, left perspective view of the bell boot in FIG. 1, opened to show the custom-colored images thereon.

FIG. 5 is a top, right perspective view of the bell boot in FIG. 4.

FIG. 6 is a rear perspective view of the bell boot in FIG. 2 in use.

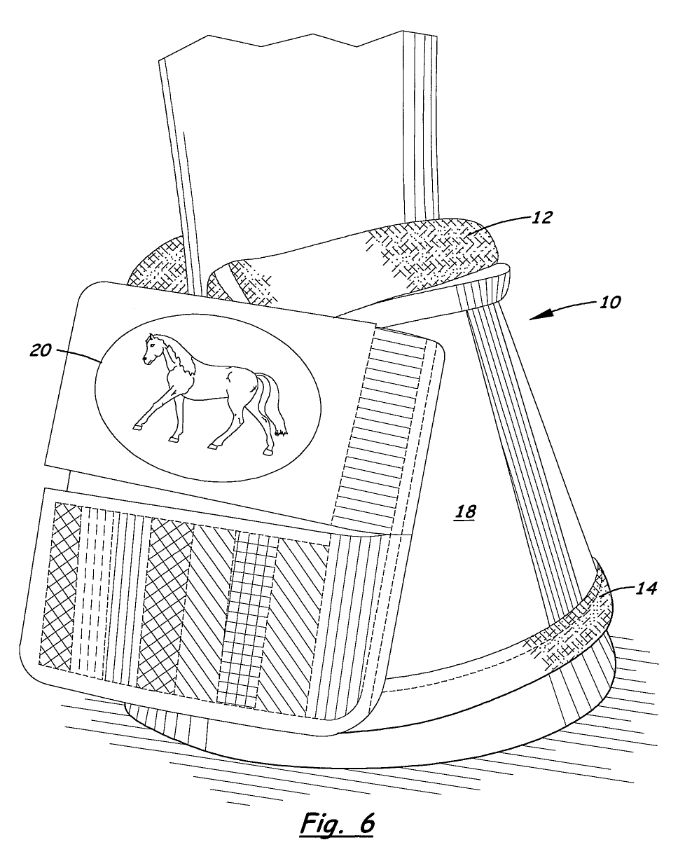

### DETAILED DESCRIPTION OF A PREFERRED EMBODIMENT OF THE INVENTION

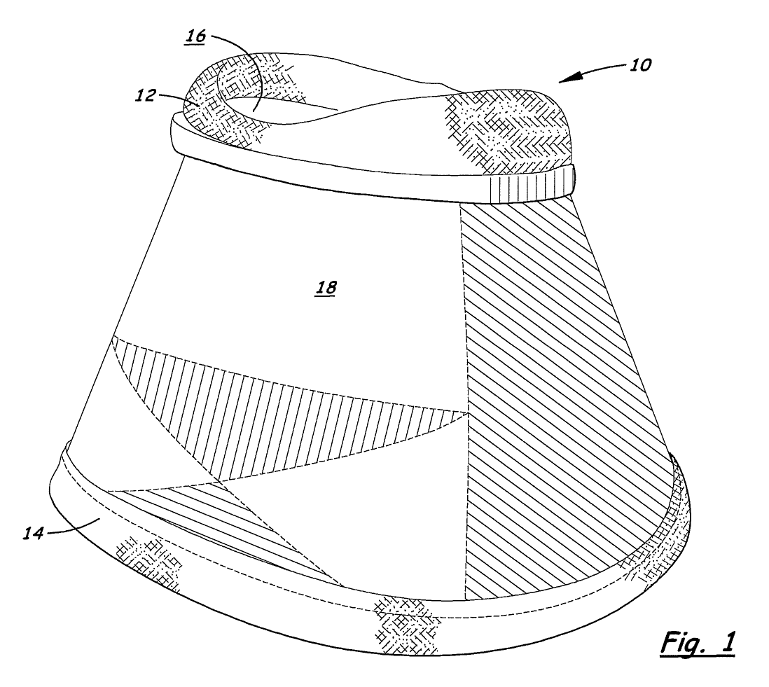

Referring to the Figures, there is depicted one, but not the only, embodiment of the present invention. In FIG. 1, “bell boot” 10 has top, soft padded ring 12 and bottom, soft padded ring 14 for protecting the skin of the lower leg and hoof of a horse from chafing of the boot. Padded rings 12 and 14 may be made of any soft fabric. Typically, especially top ring 12 may be made of two outer layers of a stretchable synthetic material sandwiching an inner layer of synthetic foam material. Typically, especially bottom ring 14 is made similarly to top ring 12, except an additional outer layer of tough, synthetic fabric is also provided in this high-wear area.

Inner surface 16 of boot 10 is preferably made similarly to top ring 12, so that the whole inside of boot is comfortable for the horse. Outer surface 18 of boot 10 is made of a special type of fabric. Preferably, outer surface 18 is made of FABLENE™, available as a bright, slick fabric from the Fabreeka International company for tough, high-wear applications like conveyor belts for rough, hard, bull, materials extracted from mines and gravel pits, for example.

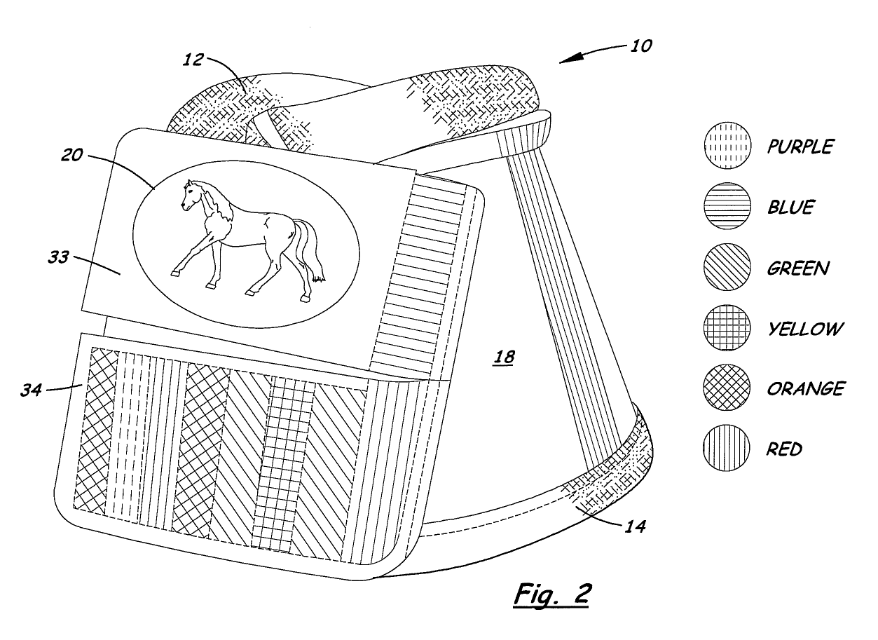

Referring to FIG. 2, there is depicted an optional space 20 on the outside surface of the bell boot of the present invention for a trademark and/or other indicia display.

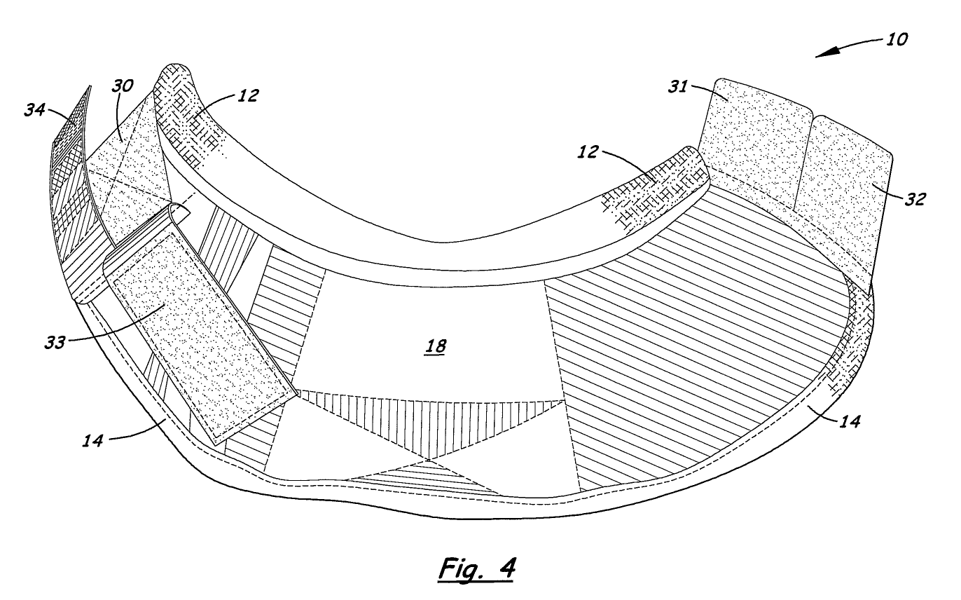

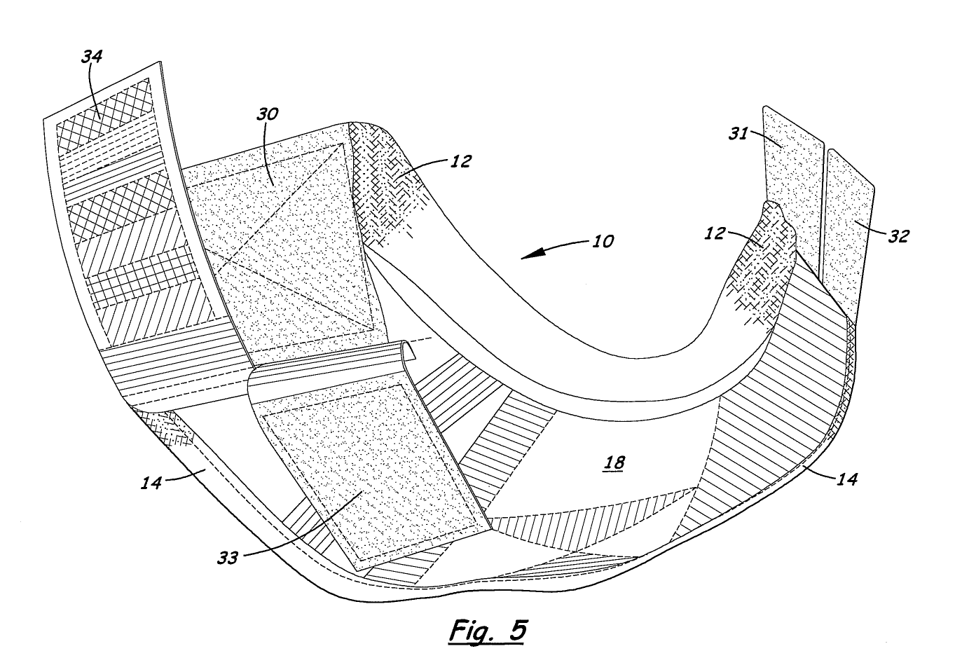

Referring to FIGS. 4 and 5, there are depicted upper hook and loop fastener patches 30 and 31 and lower hook and loop fastener patch 32. Also depicted therein are upper and lower hook and loop fastener straps 33 and 34, respectively. The fastener patches and straps are for securing the bell boot to the lower leg and hoof of the horse.

Preferably, the specific FABLENE™ material we use is CNFG-FABLENE™ Fabricated, UG-12-24. We have found that this material is durable and attractive for our protective horse tack applications. It is durable because it is tough—i.e., wear and rip resistant. We especially appreciate the FABLENE™ material's ability to effectively deflect blows from sharp hooves. We think its slick outer surface is important in this regard.

Also, the FABLENE™ material is aesthetically attractive. It is available, for example in a bright, solid, white color which maintains its brightness because it is relatively impervious to dirt, oil and water. Moreover, surprisingly, we have discovered that this FABLENE™ material readily and fastly receives the colored inks from commonly available permanent marker pens, like SHARPIE™ pens from the Sanford Co., for example. From our testing, all of the available colors are easily applied by hand strokes of the pens to the FABLENE™ material. When applied, the pen ink immediately and permanently sets in the fabric, without diffusing or running. Also, the pen ink color remains fast and bright, without fading.

Therefore, the combination of FABLENE™ material and the ink from SHARPIE™ permanent ink pens creates a new opportunity to conveniently and effectively custom-color our protective tack for horses. With the pens we can draw and paint images on the outer surface 18 of boot 10, for example. Likewise, images may also be similarly drawn and painted on the outside surface of “splint boots” and “skid boots”. These images may be made with one or more contrasting colors. Also, these images may be renewed, or “touched-up” occasionally to restore their fresh luster—however, this renewal is not often required because the original color set of the permanent ink from the pens is bright and stable.

Other materials similar to the FABLENE™ material may also be effectively used according to the invention. We have not tested an exhaustive list of materials, but we expect many types of “thermoplastic belting” materials will perform well. What we see as being important now are:
1. high wear resistance;
2. high tear resistance (a slick outer surface helps here);
3. high dirt, oil and water (stain) resistance; and,
4. a light, bright background color (for best contrast with the added color images).

Other inks from other pens besides the SHARPIE™ pens also should work well in the invention. What we see as being important here are:
1. intense ink color;
2. ink non-toxicity, preferably;
3. ink permanence; and
4. fast drying, or setting, of the ink.

Also, for manufacturing large lots of protective tack, especially lots with a continuous or repeating image design, the FABLENE™ material may be pre-colored, by screen painting, for example, prior to being cut into pieces for assembly. This way, further manufacturing economy may be obtained.

Although this invention has been described above with reference to particular means, materials and embodiments, it is to be understood that the invention is not limited to these disclosed particulars, but extends instead to all equivalents within the scope of the following claims.

We claim:

1. Custom-colorable protective tack for horses, comprising:
a tack outer surface made of a bright, slick fabric for tough, high-wear applications; and
said outer surface having received ink from a permanent marker pen to create an image thereupon.

2. The tack of claim 1 wherein the outer surface fabric is FABLENE™.

3. The tack of claim 1 wherein the outer surface fabric is CNFG-FABLENE™ Fabricated UG-12-24.

4. The tack of claim 2 wherein the outer surface fabric is a bright, solid white color.

5. The tack of claim 3 wherein the outer surface fabric is a bright, solid white color.

6. The tack of claim 1 wherein the ink is from a SHARPIE™ pen.

7. A packaged kit containing custom-colorable protective tack for horses,
said tack having an outer surface made of a bright, slick fabric for tough, high-wear applications; and
a permanent marker pen for creating an ink image on said tack outer surface.

8. The kit of claim 7 wherein outer surface fabric is FABLENE™.

9. The kit of claim 7 wherein the outer surface fabric is CNFG-FABLENE™ Fabricated UG-12-24.

10. The kit of claim 8 wherein the outer surface fabric is a bright, solid white color.

11. The kit of claim 9 wherein the outer surface fabric is a bright, solid white color.

12. The kit of claim 7 wherein the ink is from a SHARPIE™ pen.
